(19) United States
(12) Patent Application Publication
(10) Pub. No.: US 2011/0222182 A1
(43) Pub. Date: Sep. 15, 2011

(54) DISK DEVICE AND WRITE METHOD

(75) Inventor: Moon-chol PARK, Suwon-si (KR)

(73) Assignee: SAMSUNG ELECTRONICS CO., LTD., Suwon-si (KR)

(21) Appl. No.: 13/043,971

(22) Filed: Mar. 9, 2011

(30) Foreign Application Priority Data
Mar. 10, 2010 (KR) 10-2010-0021382

(51) Int. Cl. G11B 27/36

(52) U.S. Cl. 360/31; G9B/27.052

(57) ABSTRACT

A disk device and a write method that includes performing a write operation on a first data sector using first servo information, performing the write operation on a second data sector, and determining whether the write operation has been normally performed on the second data sector using a second servo signal.

### CROSS-REFERENCE TO RELATED APPLICATIONS

This application claims priority under 35 U.S.C. § 119 to Korean Patent Application No. 10-2010-0021382 filed on Mar. 10, 2010, the subject matter of which is incorporated herein in its entirety by reference.

### BACKGROUND OF THE INVENTION

The inventive concept relates to devices incorporating one or more magnetic recording disks (hereafter, “disk device”). More particularly, the inventive concept relates to disk devices capable of detecting write operation errors and compensating for same. The inventive concept also relates to write methods performed by disk devices.

Many types of disk devices write data to and read data from a magnetic disk using one or more read and/or write heads. These read/write heads do not make physical contact with the disk as they operate, but instead float closely proximate to a surface of the disk. Unfortunately, externally applied mechanical shocks can damage conventional disk devices or cause abnormal operation.

### SUMMARY OF THE INVENTION

According to an aspect of the inventive concept, there is provided a write method for a disk device, including; during a write operation indicated by a write command received by the disk drive, writing data to at least one first data sector using a corresponding first servo signal generated in accordance with first servo information, and writing data to at least one second data sector without using the first servo signal; and thereafter determining whether the write operation has been normally performed in relation to the at least one second data sector using a second servo signal generated in accordance with second servo information.

According to another aspect of the inventive concept, there is provided a disk device including; a disk having at least one first data sector, at least one second data sector, a first servo region, and a second servo region, a head that writes data to the at least one first data sector and the at least one second data sector, and reads data from the at least one first data sector and the at least one second data sector and a controller that controls the head to perform a write operation on the at least one first data sector using a first servo signal generated in accordance with first servo information read from the first servo region and a write operation on the at least one the second data sector without using the first servo signal, wherein the controller determines whether the write operation has been normally performed on the at least one second data sector using a second servo signal generated in accordance with second servo information read from the second servo region.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a disk device according to an embodiment of the inventive concept;

FIG. 2 is a flowchart summarizing a write method fir the disk device of FIG. 1, according to an embodiment of the inventive concept;

FIG. 3 is a flowchart summarizing a write method for the disk device of FIG. 1 according to another embodiment of the inventive concept;

FIG. 4 is a diagram conceptually illustrating a portion of one track from among a plurality of tracks of a disk of FIG. 1 according to an embodiment of the inventive concept;

FIG. 5A is a diagram conceptually illustrating the movement of a read/write head over the track of FIG. 4 according to an embodiment of the inventive concept;

FIG. 5B is a diagram conceptually illustrating the movement of a read/write head over the track of FIG. 4 according to another embodiment of the inventive concept;

FIG. 6 is a partial cut-away mechanical view of a hard disk device according to an embodiment of the inventive concept; and

FIG. 7 is a block diagram of an electrical circuit for a disk drive according to an embodiment of the inventive concept.

### DETAILED DESCRIPTION

The attached drawings illustrate certain embodiments of the inventive concept and may be referred to in order to gain a sufficient understanding of the inventive concept, the merits thereof, and the objectives accomplished by the implementation of the inventive concept. It should be noted, however, that the inventive concept may be variously embodied and is not limited to only the illustrated embodiments. Throughout the written description and drawings, like reference numbers and labels denote like or similar elements.

FIG. 1 is a block diagram of a disk device 100 according to an embodiment of the inventive concept.

Referring to FIG. 1, the disk device 100 may include a disk 110, a head 120, a controller 150, and a memory 170.

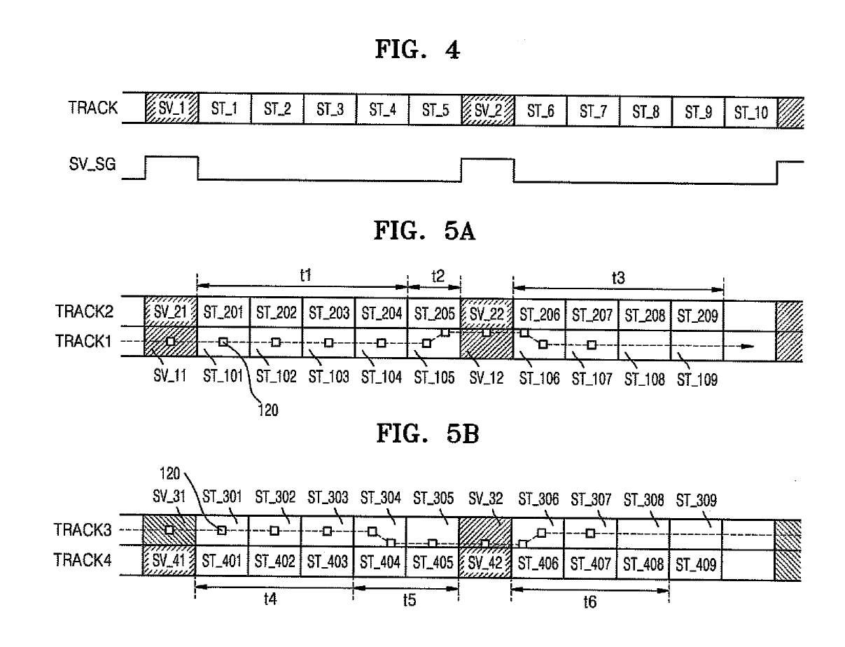

The disk 110 may be conventional in its design and generally configured to store data. The disk 110 is assumed to include at least one first data sector (hereafter, “the first data sector”), at least one second data sector (hereafter, “the second data sector”), and a plurality of servo regions. The first data sector, second data sector, and servo regions will be described in some additional detail with reference to FIG. 4.

The head 120 is conventionally configured to write data to the disk 110, and/or read data from the disk 110. In its operation, the head 120 may be further configured to write data to the first data sector and the second data sector, and/or read data from the first data sector and the second data sector. In addition, the head 120 may be further configured to read servo information from the plurality of servo regions of the disk 110.

The controller 150 essentially controls the operation of the head 120 during a write operation directed to the first data sector using a first servo signal generated in accordance with first servo information read from a first servo region among the plurality of servo regions. In addition, the controller 150 may be used to determine whether a write operation has been normally performed in relation to a given data sector using corresponding servo information read from a servo region among the plurality of servo regions. When a write operation has not been normally performed in relation to (e.g.,) the second data sector, the controller 150 controls the head 120 during a subsequent re-write operation directed to (e.g.,) the first data sector or second data sector. By using a servo interrupt service routine, the controller 150 may determine whether a write operation has been normally performed in relation to the second data sector using the second servo signal. In its design, the servo interrupt service routine is a disk device operation that determines whether a write operation has been normally performed in relation to particular data sector using a corresponding servo signal.

When the controller 150 determines that a write operation has not been normally performed for a particular data sector, the controller 150 may then store location information identifying this “failed data sector” in (e.g.,) the memory 170. The location information may include track information, head information, sector information, sector count information, and the like. However, the location information is not limited thereto, and may include other information that may specify a location of a sector on which the write operation is not normally performed.

When the location information is stored in the memory 170, the controller 150 may control the head 120 to read the resulting “re-write data” from a data sector by using the location information. The controller 150 may further be used to determine whether one or more write operation errors (hereafter “a write operation error”) is included in the re-write data, or in read data obtained during a read operation directed to a data sector. Thus, when a write operation error is detected during a read operation (or a re-write operation), the controller 150 may control the head 120 to perform a re-write operation directed to the data sector from which the write operation error arises. For example, the controller 150 may control the head 120 to read certain re-write data in relation to corresponding location information and perform a re-write operation directed to the data sector from which the write operation error arises during a time period in which the disk device 100 is in an idle state.

In addition, once the location information is stored in the memory 170, the controller 150 may control the head 120 to additionally read data from data sectors adjacent to the data sector that is the target of the re-write operation (hereafter, “the re-write data sector”). A re-write data sector may be a failed data sector during a re-write operation or any particular data sector designated for receiving re-write data when a write operation error arises during a read operation (or a re-write operation).

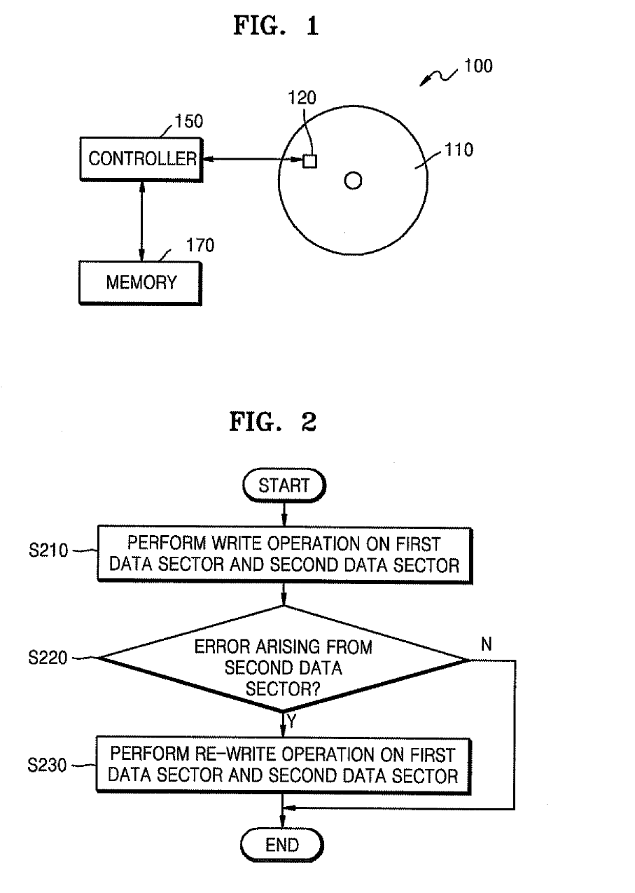

One example of operation of the disk device 100 will now be described in some additional detail with reference to FIGS. 2, 4, 5A and 5B.

FIG. 2 is a flowchart summarizing a write method for the disk device 100 of FIG. 1 according to an embodiment of the inventive concept.

Referring to FIGS. 1 and 2, the head 120 is assumed to perform a write operation directed to the first data sector and the second data sector (S210). That is, during the write operation, the head 120 writes data to the first data sector under the control of the controller 150 using the first servo signal generated from the first servo information and the second data sector under the control of the controller 150 without using the first servo signal.

The controller 150 then determines whether the write operation has been normally performed for the second data sector using the second servo signal generated from the second servo information (S220). When it is determined that the write operation has not been normally performed for the second data sector (S220=Y), the controller 150 may control the head 120 to perform a re-write operation directed to both the first data sector and the second data sector (S230).

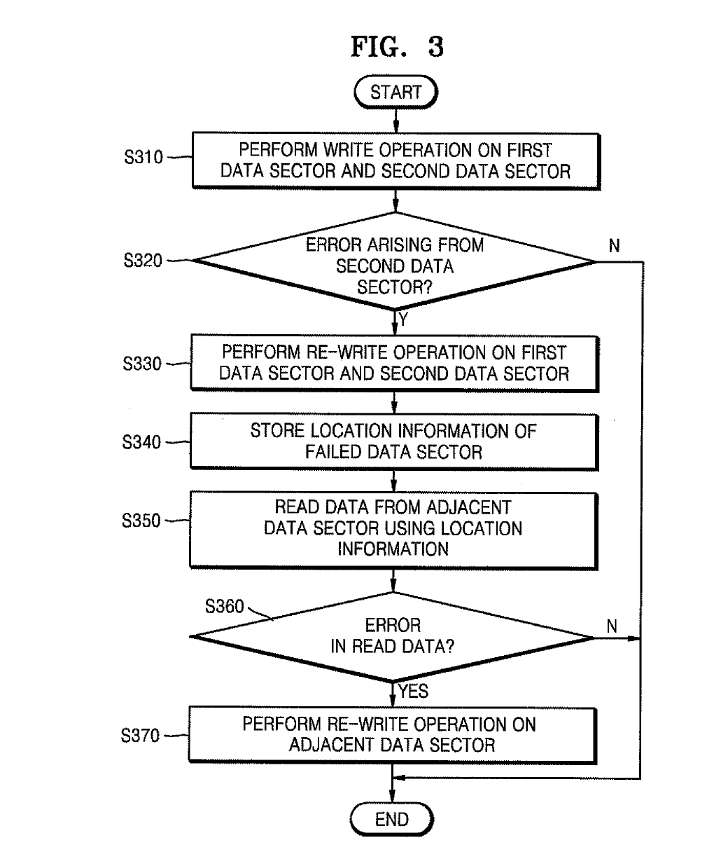

FIG. 3 is a flowchart summarizing a write method for the disk device of FIG. 1 according to another embodiment of the inventive concept.

Referring to FIGS. 1 and 3, the head 120 may be used to perform a write operation directed to the first data sector and the second data sector of the disk 110 (S310). The controller 150 then determines whether the write operation has been normally performed for the second data sector using the second servo signal generated from the second servo information (S320). When it is determined that the write operation has not been normally performed for the second data sector (S320=Y), the controller 150 may control the head 120 to perform a re-write operation directed to both the first data sector and the second data sector (S330).

In addition, following the re-write operation (S330), the controller 150 may store in the memory 170 certain location information describing one or more failed data sector(s) from which the detected write operation error arose during the write operation (S340). Thus, the controller 150 may subsequently identify and retrieve re-write data from (e.g.) the first data sector and/or the second data sector using the location information stored in the memory 170 (S350).

Additionally, controller 150 may also read data stored in one or more adjacent data sector(s) located in one or more track(s) adjacent to the current track in which the failed data sector is located (S350). The controller 150 may then be used to determine whether the data read from the adjacent data sector(s) is errant due to the same mechanical shock causing the write operation error in the second data sector ST_105 (S360). When the data read from the adjacent data sector is errant, the controller 150 may be used to perform a corresponding re-write operation directed to the adjacent data sector(s) (S370).

In certain embodiments of the inventive concept, the method steps S350 through S370 summarized in FIG. 3 may be performed when the disk device 100 is in an idle state.

FIG. 4 is a diagram conceptually illustrating a portion of a track (TRACK) from among a plurality of tracks of the disk 110 of FIG. 1 according to an embodiment of the inventive concept.

Referring collectively to FIGS. 1 through 4, the illustrated and exemplary track include a plurality of data sectors ST_1, ST_2, . . . , and a plurality of servo regions SV_1, SV_2, . . . . When the disk device 100 performs a write operation, the head 120 may write predetermined “write data” to the data sectors ST_1, ST_2, . . . , while moving along a center axis of the track. In addition, while moving over the servo regions SV_1, SV_2, . . . , the head 120 may read servo information from the respective servo regions SV_1, SV_2, . . . . This (first, second . . .) servo information may then be used to generate corresponding (first, second . . . .) servo signals SV_SG.

Thus, for example, the controller 150 may determine whether the write data has been normally written to the data sectors ST_1, ST_2, ST_3, ST_4 and ST_5 using the first servo signal SV_SG corresponding to the servo information read from the first servo region SV_1. In certain embodiments of the inventive concept, this “normal write operation” determination may be made by performing a servo interrupt service routine.

However, due to the structure and configuration of the disk 110, the controller 150 may determine whether data has been normally written in some of the data sectors ST_1, ST_2, ST_3, ST_4 and ST_5 using the first servo signal SV_SG read from the first servo region SV_1, but may not determine whether data has been normally written to the remaining data sectors on the disk 110. This is because an inner circumference of the disk 110 is less than an outer circumference, and therefore the number of servo regions that may be included on a single “inner” track is less than the number of servo regions that may be included on an “outer” track. For example, when the controller 150 uses the servo interrupt service routine, the servo interrupt service routine may be performed on an inner track and on an outer track in the same amount of time. Thus, in an inner track, the servo interrupt service routine is capable of determining whether the write operation has been normally performed on all data sectors associated with a particular read servo signal SV_SG. However, in an outer track, the servo interrupt service routine may be capable of only determining whether the write operation has been normally performed for some (i.e., less than all) of the data sectors associated with the corresponding read servo signal SV_SG.

FIG. 5A is a diagram conceptually illustrating the movement of the head 120 along the track (TRACK) of FIG. 4 according to an embodiment of the inventive concept. Hereinafter, for convenience of description, it is assumed that the controller 150 is capable of determining whether a write operation has been normally performed for up to only four (4) data sectors by using a corresponding servo signal SV_SG.

Referring to FIGS. 1 through 5A, the controller 150 is capable of determining whether the write operation has been normally performed for data sectors ST_101, ST_102, ST_103 and ST_104 within a period t1 using a first servo signal generated using servo information read from a first servo region SV_11. However, the controller 150 is not capable of determining whether the write operation has been normally performed for a data sector ST_105 within a period t2 by using the first servo signal. Thus, a data sector for which the controller 150 may timely determine whether a write operation has been normally performed using a corresponding servo signal may be termed a “first data sector” or a “timely-read data sector”. A data sector for which the controller 150 may not timely determine whether the write operation has been normally performed using a corresponding servo signal may be termed a “second data sector” or a “not-timely-read data sector”. In FIG. 5A, each of data sectors ST_101, ST_102, ST_103, ST_104, ST_106, ST_107, ST_108 and ST_109 is a first (timely-read) data sector, and the data sector ST_105 is a second (not-timely-read) data sector.

Hereinafter, for convenience of exemplary description, it is assumed that the disk device 100 receives a command indicating a write operation directed to multiple data sectors including the first data sector ST_101 and the second data sector ST_105.

In response to this write operation command, the head 120 normally moves along a center axis of a first track (TRACK1). During a first write operation verification period t1, the controller 150 determines whether the write operation has been normally performed.

However, it is further assumed that during performance of the write operation, the head 120 is knocked off the center axis of the first track due to some external shock during a period t2 (i.e., the period during which the second data sector is being written to). Since the controller 150 can not conventionally verify whether the write operation has been normally performed during the period t2 (i.e., in relation to data sectors residing outside the timely-read sequence of data sectors), the disk device 100 may actually complete the requested write operation without properly recognizing that a write operation error has arisen during the write operation as a result of the head 120 being knocked off center during the writing of write data to the second data sector ST_105 in period t2.

However, embodiments of the inventive concept preclude this errant outcome, as the controller 150 may effectively determine whether data has been normally written to a second (not-timely-read) data sector (e.g., ST_105) during the period t2. Further, this determination may be made as write data is being written to the second data sector and not just after the period t2 has elapsed. Still further, the controller 150 may complete the write operation upon determining that a write operation error has arisen during the write operation during the period t2 using a second servo signal generated from servo information read from a second servo region SV_12.

The head 120 has not normally performed the write operation for the second data sector ST_105 using the second servo signal generated from the servo information read from the second servo region SV_12. It should be noted that the foregoing write operation error may be detected only as the head 120 is moved over the data sector ST_106 (associated with the second servo region SV_12). Thus, certain conventional systems—even if they could effectively detect a write operation error in relation to a not-timely-read data sector—would erroneously begin the corresponding re-write operation at a next data sector (e.g., ST_106 in relation to ST_105). However, embodiments of the inventive concept are able to (1) properly identify a data sector as a failed data sector, and thereafter (2) properly position the head 120 during a corresponding re-write operation despite the fact that the head 120 may have moved on to a next data sector (e.g., ST_106). Thus, a write operation directed to first data sectors ST_101, ST_102, ST_103, and ST_104 as well as second data sector ST 105 may be correctly redone using an appropriately defined re-write operation.

However, when an error arises during a write operation it is often difficult (e.g., high operating overhead) to re-position the head 120 and correctly re-perform the write operation in relation to all of the “original data sectors” identified by the read command or in relation to only the particular failed data sector(s) since it is well recognized that write operation errors may arise in data sectors adjacent to a failed data sector. Thus, the re-write operation may be performed beginning with a “previous sector” located before a “current data sector” over which the head 120 is currently positioned when the write operation error is detected. That is, the previous sector may be defined as a data sector located in a certain number of data sectors in front of the current data sector. Looking at the illustrated example of FIG. 5A, a re-write operation performed as a result of a write operation error detected in relation to the second data sector ST_105 may be performed beginning at (e.g.,) first data sector ST 101, first data sector ST_104, or any one of the other “previous” data sectors in front of the failed data sector (i.e., second data sector ST_105). However, in other embodiments of the inventive concept—provided the location of the failed data sector may be accurately determined—only the failed data sector may be the subject of the subsequent re-write operation.

As noted above, when a write operation error arises, the controller 150 may store in the memory 170 certain location information related to the failed data sector. Thus, in the working example, the controller 150 will store location information identifying the second data sector ST_105. However, as further described above, since the re-write operation may be performed beginning at a previous data sector located before (or in front of) the failed data sector, the location information associated with the re-write operation may identify a previous first data sector (e.g., ST_101, ST_102, ST_103, or ST_104).

Thereafter, the controller 150 may read data from the second data sector ST_105 of the first track TRACK1 using the location information stored in the memory 170 and may determine whether the write operation has been normally performed. Then, when it has been determined that the write operation has not been normally performed, the controller 150 may control the head 120 so as to perform a corresponding re-write operation in relation to the failed data sector (the second data sector ST_105).

As has been suggested by the method summarized in FIG. 3, in addition to the foregoing failed data sector re-write operation, the controller 150 may also read data from one or more data sector (e.g., ST_205 located in a second track TRACK2 of the embodiment illustrated in FIG. 5A) adjacent to the failed data sector (e.g., ST_105 of the first track TRACK1). A determination is then made as to whether the adjacent data sector read data contains one or more data errors. Where the adjacent data sector ST_205 contains data errors, the controller 150 may control the head 120 to perform a re-write operation directed to the adjacent data sector ST_205. Through the above-described process, over track erase (OTE) errors that may occur due to internal vibration or external shocks may be detected and corrected for data wrongly over-written to an adjacent data sector located in an adjacent track.

FIG. 5B is a diagram conceptually illustrating the movement of the head 120 over another track (TRACK3) according to another embodiment of the inventive concept. Hereinafter, for convenience of description, it is assumed that the controller 150 may determine whether a write operation has been normally performed for only three (3) data sectors by using a corresponding servo signal SV_SG.

Referring to FIGS. 1 through 5B, the controller 150 is capable of determining whether the write operation has been normally performed on data sectors ST_301, ST_302 and ST_303 within a period t4 by using a third servo signal generated by using servo information read from a third servo region SV_31. However, the controller 150 is not capable of determining whether the write operation has been normally performed on data sectors ST_304 and ST_305 during a period t5 using the servo signal generated by using the servo information read from the third servo region SV_31. Hence, in FIG. 5B, data sectors ST_301, ST_302, ST_303, ST_306, ST_307 and ST_308 are first (timely-read) data sectors, and the data sectors ST_304 and ST_305 are second (not-timely-read) data sectors.

Hereinafter, like in FIG. 5A, it is assumed that the disk device 100 receives a write operation command directed to data sectors ST_301 through ST_305 for convenience of description.

The head 120 initially moves normally along a center axis of a third track (TRACK3). Thus, during the period t4, the controller 150 is able to determine whether the write operation has been normally performed. However, while performing the write operation, the head 120 is knocked off the center axis of the third track TRACK3 due to some external shock during the period t5. However, since the controller 150 does not determine whether the head 120 normally performs the write operation on the second data sector ST_105 in the period t2, the disk device 100 may finish a requested write operation without recognizing an error caused by the write operation due to the head 120 being off center in the second sectors ST_105 in the period t2. In the present embodiment, the controller 150 may determine whether data has been normally written in the period t2, not just after the period t2 elapses, and the controller 150 may finish the write operation after determining whether an error is caused by the write operation is caused during the period t5 using a second servo signal generated using servo information read from a second servo region SV_12.

For example, in FIG. 5A, the controller 150 may determine that the head 120 has not normally performed the write operation on the second data sector ST_105 by using the second servo signal generated using the servo information read from the second servo region SV_12. Conventionally, since only the first data sector ST_106 is determined to be associated with the write operation error, the location of the head 120 is corrected under an erroneous assumption in relation to the subsequent re-write operation directed to (e.g.) the first data sector ST_106. However, according to certain embodiments of the inventive concept, the controller 150 is able to correctly re-locate the head 120 and may control the head 120 to perform the corresponding re-write operation for data sectors in addition to the failed data sector (e.g., including the second data sector ST 304, any one of the first data sectors ST_301, ST_302 and ST_303, or the second data sectors ST_304 and ST_105).

However, as previously noted, following a write operation error, it is difficult for the head 120 to be correctly located during the subsequent re-write operation directed to the failed data sector. Also, the possibility of an over track error (i.e., an erroneous adjacent track over-write error) may be addressed. Thus, according to embodiments of the inventive concept, the re-write operation may be performed beginning at a previous data sector located before the failed data sector. In the working example of FIG. 5B, the re-write operation may be performed beginning from the first data sector ST_301 as opposed to the second data sector ST_304. However, if the location of all of the failed data sectors may be accurately determined, the re-write operation may be performed for only the failed data sectors.

When a write operation error arises, the controller 150 may store in the memory 170 location information for the failed data sector(s). That is, the controller 150 may store location information identifying the second data sector ST_105 in the memory 170. However, as described above, since the re-write operation may be performed from a sector that is located before the data sector where the error is generally determined to be caused by a predetermined number of sectors, location information of a first data sector (e.g., ST_302, ST_303 or the like) that is located before the second data sector ST_304 by a predetermined number of sectors may be further stored in the memory 170.

The controller 150 may read data from the second data sectors ST_304 and ST_305 of the third track TRACK3 by using the location information stored in the memory 170, and may determined whether the data is normally written. When the data is not normally written in the second data sectors ST_304 and ST_305, the controller 150 may control the head 120 so as to perform the re-write operation on the second data sectors ST_304 and ST_305. In addition, the controller 150 may read data from second data sectors ST_404 and ST_405 of a fourth track TRACK4 adjacent to the second data sectors ST_304 and ST_305 of the third track TRACK3, and may determine whether an error is caused in the read data. When data is not normally written in the second data sectors ST_404 and ST_405, the controller 150 may control the head 120 so as to perform a re-write operation on the second data sectors ST_404 and ST_405. Through the above-described process, OTE occurring due to internal vibration or external shocks may be detected to compensate for data that is wrongly written in adjacent tracks.

With reference to FIGS. 4 through 5B, cases where five data sectors are positioned between the servo regions have been described for convenience of description. However, the inventive concept is not limited to only these cases. Alternatively, when different numbers of data sectors are positioned between the servo regions, data may be written by using the above-described method.

The disk device 100 may be an optical disk device, a hard disk device, or the like. Hereinafter, a case where the disk device 100 is a hard disk device will be described. However, a write operation may also be performed on the optical disk device by using the above-described method.

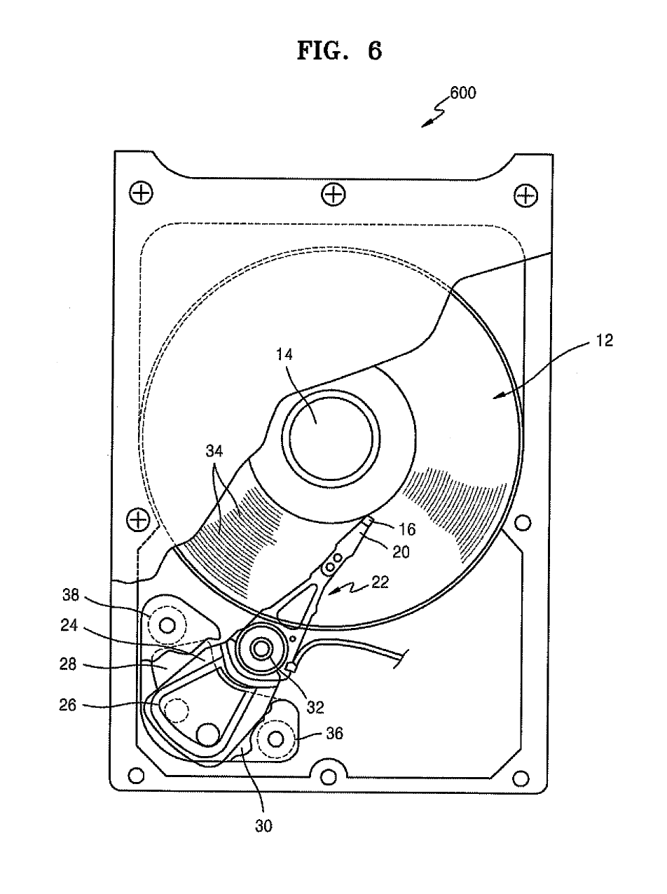

FIG. 6 is a cross-sectional view of a hard disk device 600 according to an embodiment of the inventive concept.

Referring to FIG. 6, the hard disk device 600 includes at least one disk 12 that is rotated by a spindle motor 14. The hard disk device 600 includes a converter (not shown) that is positioned adjacent to a surface of the disk 12.

The converter may detect a magnetic field of the disk 12, and may magnetize the disk 12 to read or write information from or to the rotating disk 12. Generally, the converter is coupled to the surface of the disk 12. Although the converter is described in single form, the converter includes a writing converter (so called ‘writer’) for magnetizing the disk 12, and a reading converter (so called ‘reader’) for detecting the magnetic field of the disk 12. The reading converter is included in a magneto-resistive (MR) device.

The converter may be integrated with a head 16. The head 16 is configured to generate an air bearing between the converter and the surface of the disk 12. The head 16 is integrated with a head stack assembly (HSA) 22. The HSA 22 is attached to an actuator arm 24 including a voice coil 26. The voice coil 26 is positioned adjacent to a magnetic assembly 28 so as to specify a voice coil motor (VCM) 30. A current supplied to the voice coil 26 generates torque for rotating the actuator arm 24 with respect to a bearing assembly 32. The actuator arm 24 may be operated over the surface of the disk 12 to move the converter.

Generally, information is stored in circular tracks 34 of the disk 12. Each of the tracks 34 includes a plurality of sectors. Each sector includes a data field, a servo field. A preamble, a servo address/index mark (SAM/SIM), a gray code, and a burst signal. The converter may be moved across the surface of the disk 12 in order to read or write information from or to various tracks.

The head 16 is configured to generate an air bearing between the surface of the disk 12 and the reader and the writer, and includes a heater (not shown) for heating a structure for generating the air bearing.

When a plurality of disks 12 are installed in the hard disk device 600, a plurality of heads 16 are installed to correspond to respective surfaces of the disks 12. For example, when two disks are installed in the hard disk device 600, four heads 16 are installed in the HSA 22. In addition, each of the heads 16 includes a heater.

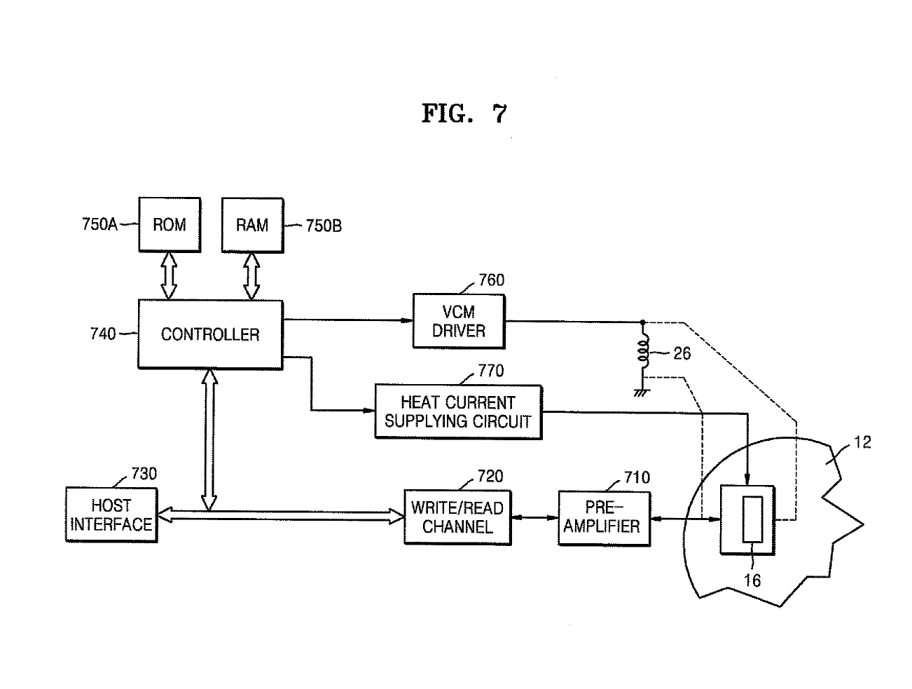

FIG. 7 is a block diagram of an electrical circuit of a disk drive (i.e., the hard disk drive device of FIG. 6), according to an embodiment of the inventive concept.

Referring to FIG. 7, the disk drive includes the disk 12, the head 16, a pre-amplifier 170, a write/read channel 720, a host interface 730, a controller 740, a read only memory (ROM) 750A, a random access memory (RAM) 750B, a voice coil motor (VCM) driver 760, and a heater current supplying circuit 770.

Firmware and control information for controlling the disk drive are installed in the ROM 750A. The ROM 750A may correspond to the memory 170 of FIG. 1. Information required to drive the disk drive read from the ROM 750A or the disk 12 at an initial state of driving the disk drive may be stored in the RAM 750B.

The controller 740 analyzes a command received from a host device (not shown) through the host interface 730, and performs a controlling operation corresponding to the analysis result. The controller 740 may apply respective corresponding control signals to VCM driver 760 and the current supplying circuit 770 in order to control movement of the head 16. The controller 740 may correspond to the controller 150 of FIG. 1.

First, an operation of the disk drive will be described.

In a data read mode, the disk drive primarily amplifies an electrical signal detected by the reading converter of the head 16 from the disk 12. Then, the write/read channel 720 controls gain by using an automatic gain control circuit (not shown), amplifies an analog signal amplified by the pre-amplifier 170 to a predetermined level, encodes the analog signal amplified by the automatic gain control circuit to the predetermined level to a digital signal that is readable by a host device (not shown), converts the digital signal into stream data, and transmits the stream data to the host device through the host interface 730.

Next, in a write mode, the disk drive converts data that is received from the host device through the host interface 730 to a binary data stream suited to a writing channel by using the write/read channel 720, and then writes a writing current amplified by the pre-amplifier 170 in the disk 12 through the writing converter of the head 16.

The write/read channel 720 provides information required to control track-seeking and track-following while reproducing preamble, SAM/SIM, a gray code and burst signals, which are written in a servo field of the disk 12. The write/read channel 720 provides information required to control the track-seeking and the track-following while reproducing a reference servo pattern that is written on a surface of a disk of a plurality of disks by using a reference head, during a servo copy operation.

While the inventive concept has been particularly shown and described with reference to exemplary embodiments thereof, it will be understood that various changes in form and details may be made therein without departing from the scope of the following claims.

What is claimed is:

1. A write method for a disk device, comprising:
during a write operation indicated by a write command received by the disk drive, writing data to at least one first data sector using a corresponding first servo signal generated in accordance with first servo information, and writing data to at least one second data sector without using the first servo signal; and thereafter,
determining whether the write operation has been normally performed in relation to the at least one second data sector using a second servo signal generated in accordance with second servo information.

2. The write method of claim 1, wherein determining whether the write operation has been normally performed in relation to the at least one second data sector is performed during a servo interrupt service routine.

3. The write method of claim 1, further comprising:
reading the first servo information from a first servo region to generate the first servo signal, and reading second servo information from a second servo region adjacent to first servo region to generate a second servo signal.

4. The write method of claim 1, further comprising:
upon determining that the write operation has not been normally performed on the at least one second data sector, performing a re-write operation directed to the at least one first data sector and the at least one second data sector.

5. The write method of claim 4, further comprising:
storing location information identifying the at least one second data sector as a failed data sector to define a beginning data sector for the re-write operation.

6. The write method of claim 4, further comprising:
storing location information identifying a previous data sector located before the at least one second data sector as a failed data sector to define a beginning data sector for the re-write operation.

7. The write method of claim 5, further comprising:
reading re-write data to be written during the re-write operation in accordance with the location information;
determining whether the re-write data includes a data error; and
upon determining that the re-write data includes a data error, performing a re-write operation directed to the data sector storing the re-write data.

8. The write method of claim 7, wherein the data sector storing the re-write data is an adjacent data sector located in a track adjacent to a track in which the failed data sector is located.

9. A disk device comprising:
a disk having at least one first data sector, at least one second data sector, a first servo region, and a second servo region;
a head that writes data to the at least one first data sector and the at least one second data sector, and reads data from the at least one first data sector and the at least one second data sector; and
a controller that controls the head to perform a write operation on the at least one first data sector using a first servo signal generated in accordance with first servo information read from the first servo region and a write operation on the at least one the second data sector without using the first servo signal,
wherein the controller determines whether the write operation has been normally performed on the at least one second data sector using a second servo signal generated in accordance with second servo information read from the second servo region.

10. The disk device of claim 9, wherein the controller determines whether the write operation has been normally performed on the at least one second data sector using the second servo signal during a servo interrupt service routine.

11. The disk device of claim 9, wherein the controller controls the head to perform a re-write operation on the at least one first data sector and the at least one second data sector upon determining that write operation has not been normally performed on the second data sector.

12. The disk device of claim 11, further comprising:
a memory that stores location information identifying the second data sector, as stored by the controller upon determining that the write operation has not been normally performed on the at least one second data sector.

13. The disk device of claim 12, wherein the controller controls the head to read re-write data to be written to the at least one second data sector using the location information, and to perform a re-write operation on the at least one second data sector.

14. The disk device of claim 12, wherein the controller controls the head to read re-write data from an adjacent data sector located on a track adjacent to a current track including the at least one second data sector using the location information, and to perform a re-write operation on the adjacent data sector.
